(19) United States
(12) Patent Application Publication
(10) Pub. No.: US 2025/0004689 A1
(43) Pub. Date: Jan. 2, 2025

(54) PROCESSING APPARATUS, DISPLAY DEVICE AND PROCESSING METHOD

(71) Applicant: Lenovo (Beijing) Limited, Beijing (CN)

(72) Inventor: Xiaoxi CHEN, Beijing (CN)

(21) Appl. No.: 18/759,085

(22) Filed: Jun. 28, 2024

(30) Foreign Application Priority Data
Jun. 30, 2023 (CN) 202310805232.3

(51) Int. Cl. G06F 3/14

(52) U.S. Cl. CPC G06F 3/1454

(57) ABSTRACT

A processing apparatus includes: a first interface configured to obtain first input data, the first input data coming from a collection device; a second interface configured to obtain second input data, the second input data coming from a source different from that of the first input data; and a processing module configured to convert the first input data into a first display signal, convert the second input data into a second display signal, and output one or more of the first display signal and the second display signal.

### CROSS-REFERENCE TO RELATED APPLICATION

This application claims priority to Chinese Patent Application No. 202310805232.3, filed on Jun. 30, 2023, and the entire content of which is incorporated herein by reference.

### TECHNICAL FIELD

The present disclosure relates to the technical field of display technology, and more particularly, to a processing apparatus, a display device, and a processing method.

### BACKGROUND

Many display devices include a device with built-in image acquisition function, such as a camera. When a user uses the built-in image acquisition function to collect images and display the collected images in a display area through software, if a display content needs to be displayed in full screen at the same time, the collected images in the display area may be blocked by the display content, resulting in the user not being able to see the collected images.

### SUMMARY

One aspect of the present disclosure provides a processing apparatus. The processing apparatus includes: a first interface configured to obtain first input data, the first input data coming from a collection device; a second interface configured to obtain second input data, the second input data coming from a source different from that of the first input data; and a processing module configured to convert the first input data into a first display signal, convert the second input data into a second display signal, and output one or more of the first display signal and the second display signal.

Another aspect of the present disclosure provides a display device. The display device includes: a first processing apparatus including a first interface and a second interface and configured to convert first input data obtained through the first interface into a first display signal, convert second input data obtained through the second interface into a second display signal, and output one or more of the first display signal and the second display signal, the first input data coming from a collection device, the second input data coming from a source different from that of the first input data; and a display panel communicatively connected to the first processing apparatus and configured to receive one or more of the first display signal and the second display signal for display. The first display signal and the second display signal are a same type of signals, the display panel includes a plurality of pixel units, and the first display signal and the second display signal are used to control display of the plurality of pixel units.

Another aspect of the present disclosure provides a processing method. The processing method includes: obtaining first input data and converting the first input data into a first display signal, the first input data coming from a collection device; obtaining second input data and converting the second input data into a second display signal, the second input data coming from a source different from that of the first input data; and outputting one or more of the first display signal and the second display signal.

### BRIEF DESCRIPTION OF THE DRAWINGS

FIG. 1 is a structural diagram of a processing apparatus according to some embodiments of the present disclosure;

FIG. 2 is a structural diagram of a first display device according to some embodiments of the present disclosure;

FIG. 3 is a flowchart of a processing method according to some embodiments of the present disclosure;

FIG. 4 is a schematic diagram of a program implementation of a processing method according to some embodiments of the present disclosure; and

FIG. 5 is a structural diagram of an electronic device according to some embodiments of the present disclosure.

### DETAILED DESCRIPTION OF THE EMBODIMENTS

To make the objectives, technical solutions, and advantages of the present disclosure clearer, the technical solutions in the embodiments of the present disclosure will be clearly and completely described below in conjunction with the accompanying drawings in the embodiments of the present disclosure. Obviously, the embodiments described herein are merely some of the embodiments of the present disclosure, but not all of them. Based on the embodiments in the present disclosure, all other embodiments obtained by those of ordinary skill in the art without creative efforts should fall within the scope of protection of the present disclosure. Under the circumstances of no conflict, the embodiments and features in the present disclosure may be combined with each other arbitrarily. The processes illustrated in the flowcharts of the drawings may be a set of computer-executable instructions performed in a computer system. Although a logical order is shown in the flowcharts, in some cases the processes shown or described may be performed in an order different from described herein.

The technical solutions of the present disclosure will be further described in detail below with reference to the accompanying drawings and various embodiments of the description.

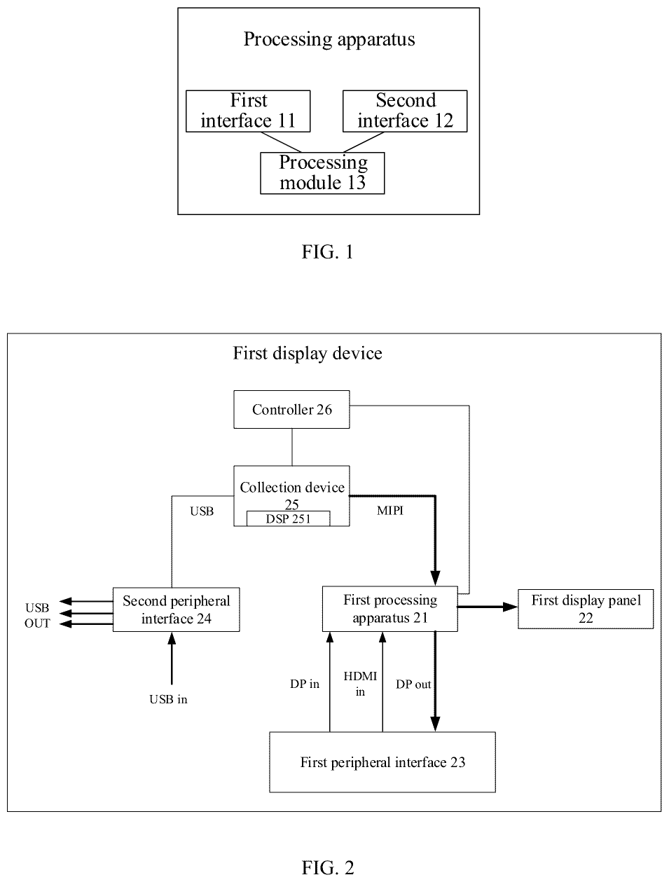

FIG. 1 is a structural diagram of a processing apparatus according to some embodiments of the present disclosure. The processing apparatus may be a main control chip Scalar of a display device. The main control chip Scalar may be used to adjust brightness, contrast, and other display parameters of the display device. As shown in FIG. 1, the processing apparatus includes: a first interface 11, a second interface 12, and a processing module 13. The first interface 11 is used to connect with a collection device and to obtain first input data from the collection device.

The first interface 11 may be connected to a Mobile Industry Processor Interface (MIPI) of the collection device, which may be an image collection device (such as a camera). The collection device may convert collected image data into a digital signal (MIPI signal) through a digital signal processor (DSP) and may transmit the digital signal to the processing apparatus. MIPI signals may be understood as video signals of a same type as high-definition multimedia interface (HDMI) signals and display port (DP) signals. The DSP may be included in the collection device or the processing apparatus.

The second interface 12 is used to obtain second input data. The second input data and the first input data are obtained from different sources.

In some embodiments, the second interface 12 may be an interface connected to a graphics card and used to receive the second input data from the graphics card.

In some embodiments, the second interface 12 may be an interface connected to an HDMI device and used to receive the second input data from the HDMI device.

In some other embodiments, the second interface 12 may also be an interface connected to a DP device and used to receive the second input data from the DP device.

The processing module 13 is configured to convert the first input data into a first display signal, convert the second input data into a second display signal, and output one or more of the first display signal and the second display signal.

The processing module 13 may be connected to one or more display devices, and is configured to output one or more of the first display signal and the second display signal to the one or more display devices.

The processing module 13 may convert the first input data into the first display signal according to display parameters carried in the first input data, such that the first input data can be displayed successfully.

The display parameters of the first input data are determined based on a preset table in the collection device. The preset table stores correspondence relationship between each display parameter and each digital signal processor. That is, the preset table stores multiple resolutions, refresh rates, and other display parameters (such as 10 display parameters) supported by the processing apparatus, and the collection device only supports one or more of the 10 display parameters.

The processing apparatus provided by the present disclosure may directly receive the first input data from the collection device through the first interface. The first input data is a digital signal (such as a MIPI signal, which is a video signal) converted from an image signal by DSP. The first input data is not an image signal. The first input data is then converted by the processing apparatus into a first display signal that can be recognized by a display device and is outputted to the display device. This solution uses hardware to achieve image display, and does not rely on software (operating system or third-party application). Data collected by a camera is directly outputted for display. Thus, when a user displays another image in full screen, the user displayed image does not block the image displayed using the data collected by the camera.

FIG. 2 is a structural diagram of a first display device according to some embodiments of the present disclosure. The first display device can be a display. As shown in FIG. 2, the first display device includes: a first processing apparatus 21 and a first display panel 22. The first processing apparatus 21 may be a main control chip (Scalar) of the first display device. The first processing apparatus 21 includes a first interface, a second interface, and a processing module. With the help of the processing module, the first processing apparatus 21 is used to convert the first input data obtained through the first interface into the first display signal, and to convert the second input data obtained through the second interface into the second display signal, and to output one or more of the first display signal and the second display signal. The first input data is collected by the collection device, and the second input data is collected from a source different from that of the first input data.

For example, the second input data comes from an HDMI device, a DP device, etc. of a graphics card or a peripheral.

The first processing apparatus is the same as the processing apparatus shown in FIG. 1. For details of its implementation, reference can be made to the relevant description of the processing apparatus shown in FIG. 1. The description thereof will not be repeated herein.

The first display panel 22 is communicatively connected to the first processing apparatus 21 and is used to receive one or more of the first display signal and the second display signal for display. The first display signal and the second display signal are the same type of signals (e.g., both are LVDS signals, or both are eDP signals). The first display panel includes a plurality of pixel units, and the first display signal and the second display signal are used to control display of the plurality of pixel units.

The first display signal and the second display signal are signals, such as LVDS, eDP signals, etc., that are converted based on the display parameters carried in the first input data and the second input data and can be directly recognized by the first display panel 22. If the first display panel 22 is an LCD display, the first display signal and the second display signal may control transmittance of an LCD liquid crystal layer. If the first display panel 22 is an OLED display, the first display signal and the second display signal may control brightness or darkness of a plurality of RGB light-emitting units of an OLED liquid crystal layer.

The first display panel 22 includes a first display window. The first processing apparatus 21 may display a second display window on the first display panel 22 according to the display parameters carried in the first input data to output the first display signal corresponding to the first input data through the second display window. The display parameters of the second display window may be smaller than the first display window, and the second display window is located in an upper display layer of the first display window. As such, by displaying the first input data in a picture-in-picture format, when the user displays the second input data in full screen, the first input data will not be blocked.

In some embodiments, the first display device further includes a first peripheral interface 23. The first peripheral interface 23 is used to connect to a second display device. The second display device exists independently of the first display device.

The first processing apparatus 21 further includes a third interface, which may be a DP interface or an HDMI interface. The third interface is used to output the first input data to the second display device through the first peripheral interface 23. The first input data is displayed on the second display device.

In some embodiments, the first display device further includes a second peripheral interface 24 and a collection device 25. The second peripheral interface 24 is used to connect to a third device (not shown in the drawing) with input and output functions. The third device exists independently of the first display device. For example, the third device is a mobile phone, a computer, a PAD, etc.

In some embodiments, the second peripheral interface 24 may be a universal serial bus (USB) interface. The second peripheral interface 24 may also be a USB extender USB HUB interface.

The collection device 25 may be a camera. The collection device 25 may be used to collect image information and convert the image information into the first input data. The first input data may be, for example, a MIPI signal, which is converted by a signal processor 251 of the collection device 25 from image data collected by the collection device 25.

The digital signal processor 251 may belong to the collection device 25, the first processing apparatus 21, or the first display device.

The collection device 25 further includes a fourth interface and a fifth interface. The fourth interface is communicatively connected with the first interface and is used to transmit the first input data to the first processing apparatus 21. The fifth interface is communicatively connected with the second peripheral interface 24 and is used to output the first input data to the third device.

It should be understood that the camera in this application includes two paths. The first path is a MIPI signal path, and the second path is a USB signal path. As such, by transmitting the first input data collected by the collection device (e.g., the video signal converted from the collected image signal) to an external third device, when the user displays the second input data (such as PPT) in full screen on the first display device, the first input data may be output through the third device, such that the user can always see images captured by the camera.

When a communication connection is successfully established between the digital signal processor 251 and the first processing apparatus 21, the digital signal processor 251 will convert the image data collected by the collection device 25 into a digital signal, that is, a MIPI signal or a media signal.

In some embodiments, the first display device further includes a controller 26. The controller 26 is connected to the collection device 25. In case that the digital signal processor 251 in the collection device 25 fails to connect to the first processing apparatus 21 or the second peripheral interface 24 (USB hub), the collection device 25 is controlled to enter a standby state to reduce device power consumption.

In some embodiments, the controller 26 may also be connected to the first processing apparatus 21 to control the first processing apparatus 21 to receive the first input data sent from the collection device 25 when the first display device displays in a picture-in-picture display mode. That is, if the user sets captured images to be displayed in the form of picture-in-picture, the first processing apparatus 21 receives the video signal sent from the collection device 25. Otherwise, the collection device 25 (e.g., the camera) sends the image data to an operating system, and the first processing apparatus 21 receives the video signal sent from the operating system. The video signal includes at least one of a MIPI signal, a HDMI signal, a DP signal, a DVI signal, a VGA signal, an SDI signal, or a S-Video signal.

In some embodiments, the first display panel 22 is further configured to determine a first pixel array for display based on the first display signal, and to determine a second pixel array for display based on the second display signal. In the case where the first display panel 22 simultaneous displays based on the first display signal and the second display signal, the first pixel array interferes with the second pixel array.

The first pixel array and the second pixel array are located in different display layers. The first pixel array interferes with the second pixel array in one of the following scenarios. When the first display panel 22 simultaneously displays based on the first display signal and the second display signal, and an overlap occurs between the first pixel array and the second pixel array, the first pixel array blocks a portion of a display area corresponding to the second pixel array, which includes a display content. That is, the portion of the display area corresponding to the second pixel array is blocked by the first pixel array, and the display content in the portion of the display area is blocked.

When the first display panel 22 simultaneously displays based on the first display signal and the second display signal, and an overlap occurs between the first pixel array and the second pixel array, the first pixel array blocks a portion of the display area corresponding to the second pixel array, and the display content in the blocked portion of the display area is moved to another portion of the display area that is not blocked by the first pixel array for display. That is, the portion of the display area corresponding to the second pixel array is blocked by the first pixel array, and the display content in this portion of the display area is not blocked.

When the first display panel 22 simultaneously displays based on the first display signal and the second display signal, and no overlap occurs between the first pixel array and the second pixel array, the first pixel array displays in a first display area of the first pixel panel 22, the second pixel array displays in a second display area of the first display panel 22. The first display area and the second display area do not overlap. The first display area and the second display area together form the entire display area of the first display panel 22.

In the embodiments of the present disclosure, the portion of the display area of the second pixel array blocked by the first pixel array may change with the movement of the second pixel array. That is, the first pixel array is located on a display layer above the second pixel array, and the first pixel array may move in the display layer according to a drag instruction, such that the blocked portion of the display area of the second pixel array can be moved. As such, the blocked portion of the display area of the second pixel array can be revealed.

In the embodiments of the present disclosure, in the scenario where the first display signal and the second display signal are displayed simultaneously on the same display panel, a Scalar signal is set to the highest priority and is displayed on the top layer. When the second display signal is displayed in full screen or non-full screen, it is ensured that the first display signal will not be blocked by the second display signal.

In some embodiments, the first display device further includes a second processing apparatus (not shown in the drawing). The second processing apparatus may be a graphics card. The second processing apparatus is used to communicatively connect to the second interface of the first processing apparatus 21. The second processing apparatus generates the second input data and sends the second input data to the first processing apparatus 21 through the second interface.

The first display device provided by the present disclosure directly obtains the first input data from the image collection device through the first processing apparatus (Scalar). Because the first input data is a digital signal (e.g., a MIPI signal) converted from the image data collected by the image collection device, it is a hardware-based data conversion solution. The image data from the camera can be displayed or output without relying on software (operating system or third-party application). Thus, when the user displays an image in full screen, the user displayed image is prevented from blocking the image captured by the camera.

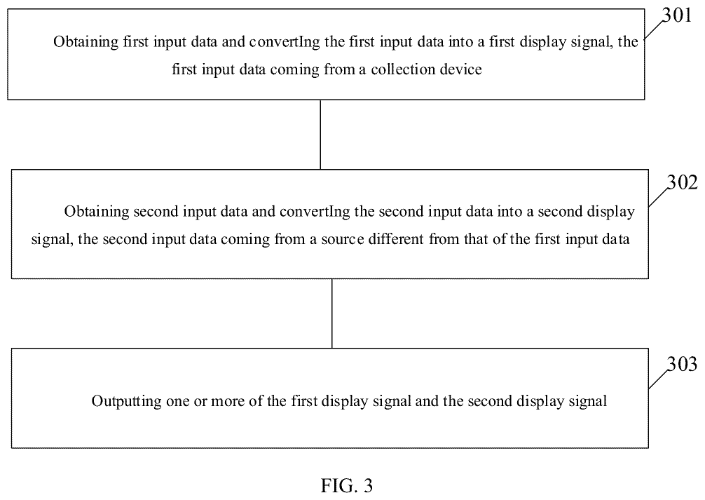

FIG. 3 is a flowchart of a processing method according to some embodiments of the present disclosure. As shown in FIG. 3, the processing method includes the following processes.

At 301: first input data is obtained and converted into a first display signal, the first input data coming from a collection device.

The collection device may be an image collection device, and the first input data may be a digital signal or a video signal converted from image data by a digital signal processor in the image collection device. The video signal may be a MIPI signal. The video signal may be in any of three formats: NTSC, PAL, and SECAM. The display signal is obtained by converting the video signal based on display parameters carried in the video signal. The display signal, such as a LVDS signal, an eDP signal, etc., may be directly recognized by the display panel. The display signal controls transmittance of a liquid crystal layer (for an LCD display), or brightness and darkness of a plurality of RGB light-emitting units (for an OLED display).

At 302, second input data is obtained and converted into a second display signal, the second input data coming from a source different from that of the first input data.

The second input data may come from a graphics card, a HDMI interface, or a DP interface. The second input data may originate from an external device.

At 303, one or more of the first display signal and the second display signal is outputted.

In some embodiments, one or more of the first display signal and the second display signal may be outputted to a first display device to display first display information corresponding to the first display signal and/or second display information corresponding to the second display signal. That is, two display signals are displayed simultaneously through the same display device.

In some embodiments, the first display signal may be outputted to a first display device to display the first display information corresponding to the first display signal through the first display device; and/or the second display signal is outputted to a second display device to display the second display information corresponding to the second display signal through the second display device. The second display device is independent of the first display device. That is, two display signals are displayed respectively through different display devices.

In some embodiments, displaying the first display information corresponding to the first display signal and/or the second display information corresponding to the second display signal through the first display device includes: displaying all or a portion of the first display information in a first display area of the first display device; and displaying all or a portion of the second display information in a second display area of the first display device. The first display area and the second display area together form an entire display area or a portion of the entire display area of the first display device. A first pixel array corresponding to the first display area interferes with a second pixel array corresponding to the second display area.

The first display area and the second display area are located on different display layers, and a first display layer where the first display area is located is located above a second display layer where the second display area is located.

The first pixel array corresponding to the first display area interfering with the second pixel array corresponding to the second display area includes the following processes. If an overlap occurs between the first display area and the second display area, the first display area blocks at least a portion of the second display area, and a display content in the blocked portion of the second display area is also blocked.

In some embodiments, if an overlap occurs between the first display area and the second display area, and the first display area blocks at least a portion of the second display area, the display content of the blocked portion of the second display area is moved to a display area that is not blocked by the first display area. That is, the display content displayed initially in the portion of the second display area blocked by the first display area will no longer be blocked.

The first display area may also be displaced according to a drag instruction to change the blocked portion of the second display area, such that the display content of the second display area can be fully presented.

In some embodiments, if no overlap occurs between the first display area and the second display area, the first display area and the second display area together form the entire display area of the display device.

The processing method provided by the present disclosure includes directly obtaining the first input data from the collection device and outputting the first display signal of the first input data. Because the first input data is a digital signal (e.g., a MIPI signal) converted from the image data collected by the collection device, it is a hardware-based data conversion solution without relying on software (operating system or third-party application). The data from the camera may be displayed and outputted. Thus, when the user displays a display image in full screen, the user displayed display image is prevented from blocking the image captured by the camera.

It should be noted that when performing data processing, the processing method provided by the present disclosure shares the same concept as the first display device previously described in the embodiments of the present disclosure. The specific implementation process can be found in the description of the embodiments of the first display device, and will not be described again herein.

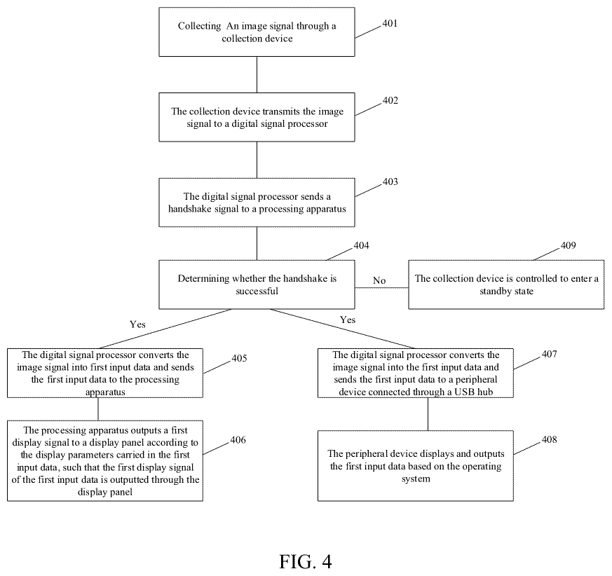

FIG. 4 is a schematic diagram of a program implementation of a processing method according to some embodiments of the present disclosure. As shown in FIG. 4, the processing method includes the following processes.

At 401, an image signal is collected through a collection device.

At 402, the collection device transmits the image signal to a digital signal processor.

The digital signal processor is used to convert the image signal into a video signal, such as a MIPI signal. The digital signal processor may be included in the collection device, or may exist independently of the collection device.

At 403, the digital signal processor sends a handshake signal to a processing apparatus.

The processing apparatus is a main control chip Scalar of a display device.

At 404, whether the handshake is successful is determined.

If the handshake is successful, 405 and 407 are performed. If the handshake fails, 409 is performed.

At 405, the digital signal processor converts the image signal into first input data and sends the first input data to the processing apparatus.

The first input data is a video signal converted from the image signal. The first input data carries display parameters, which represent resolution and aspect ratio of a display window, such as 16:9, 5:4, 1:1, etc.

At 406, the processing apparatus outputs a first display signal to a display panel according to the display parameters carried in the first input data, such that the first display signal of the first input data is outputted through the display panel.

The processing method is completely independent of the operating system and third-party applications. When a user displays a display image in full screen, the user displayed display image is prevented from blocking the image captured by the camera.

At 407: the digital signal processor converts the image signal into the first input data and sends the first input data to a peripheral device connected through a USB hub.

At 408, the peripheral device displays and outputs the first input data based on the operating system.

At 409, the collection device is controlled to enter a standby state.

Through the processing method provided by the present disclosure, the image signal collected by the display's camera can not only be sent to a smart device such as a computer, but also to the Scalar display chip. The Scalar display chip displays the display content on the same display screen (i.e., a monitor) in a picture-in-picture (PIP) form. Alternatively, the Scalar display chip sends the display content to another monitor. The hardware-based data conversion solution displays and outputs the data from the camera without relying on software (operating system or third-party application). Thus, when the user displays a display image in full screen, the user displayed display image is prevented from blocking the image captured by the camera.

The present disclosure also provides an electronic device. The electronic device includes a processor and a memory for storing a computer program that can be executed by the processor. When being executed by the processor, the computer program causes the processor to perform the processes in the processing method.

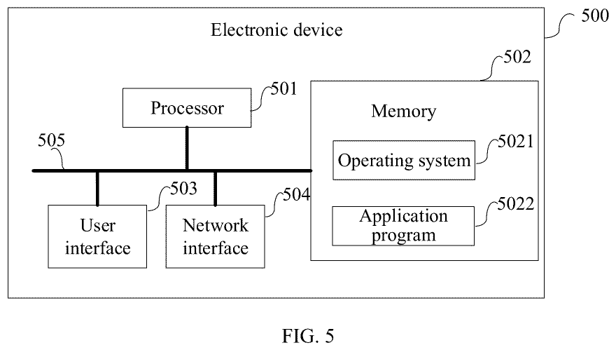

FIG. 5 is a structural diagram of an electronic device according to some embodiments of the present disclosure. The electronic device 500 may be a mobile phone, a computer, a digital broadcast terminal, an information transceiver device, a game console, a tablet device, a medical device, a fitness device, a personal digital assistant, and other suitable terminals. As shown in FIG. 5, the electronic device 500 includes: at least one processor 501, a memory 502, at least one network interface 504, and a user interface 503. Various components in the electronic device 500 are coupled together by a bus system 505. The bus system 505 is used to facilitate communication between these components. In addition to a data bus, the bus system 505 also includes a power bus, a control bus, and a status signal bus. However, for the sake of clarity, various buses are labeled as the bus system 505 in FIG. 5.

The user interface 503 may include a display, a keyboard, a mouse, a trackball, a click wheel, keys, buttons, a touch pad, or a touch screen, etc.

The memory 502 may be a volatile memory or a non-volatile memory, and may also include both volatile and non-volatile memories. The non-volatile memory may be a read-only memory (ROM), a programmable read-only memory (PROM), an erasable programmable read-only memory (EPROM). Only Memory), an electrically erasable programmable read-only memory (EEPROM), a ferromagnetic random-access memory (FRAM), a flash memory, a magnetic surface memory, an optical disk, or a compact disc read-only memory (CD-ROM). The magnetic surface memory may be a magnetic disk memory or a tape memory. The volatile memory may be a random-access memory (RAM), which is used as an external cache. By way of illustration, but not limitation, many forms of RAM are available, such as a static random-access memory (SRAM), a synchronous static random-access memory (SSRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a SyncLink dynamic random-access memory (SLDRAM), and a direct Rambus random-access memory (DRRAM). The memory 502 described in the embodiments of the present disclosure is intended to include, but is not limited to, these and any other suitable types of memories.

The memory 502 in the embodiments of the present disclosure is used to store various types of data to support the operation of the electronic device 500. Examples of these data include: any computer program used to operate on the electronic device 500, such as operating system 5021 and application program 5022; contact data; phonebook data; messages; pictures; audio, etc. The operating system 5021 includes various system programs, such as a framework layer, a core library layer, and a driver layer, etc., which are used to provide various basic services and process hardware-based tasks. The application program 5022 may include various application programs, such as a media player, a browser, etc., and is used to provide various application services. The program that implements the processing method provided by the embodiments of the present disclosure may be included in the application program 5022.

The processing method provided by the embodiments of the present disclosure may be applied to the processor 501 or implemented by the processor 501. The processor 501 may be the main control chip of a display panel and may include signal processing capabilities. During the implementation process, each step of the processing method may be completed by instructions in the form of hardware integrated logic circuits or software executed by the processor 501.

In some embodiments, the electronic device 500 may be configured by one or more application specific integrated circuits (ASICs), DSPs, programmable logic devices (PLDs), complex programmable logic devices (CPLDs), field-programmable gate arrays (FPGAs), general-purpose processors, controllers, micro controller units (MCUs), microprocessors, or other electronic component implementation used to execute the processing methods.

The present disclosure also provides a computer-readable storage medium, such as a memory 502 storing a computer program. The computer program may be executed by the processor 501 of the electronic device 500 to perform the processes of the processing method. The computer-readable storage medium may be a FRAM, a ROM, a PROM, an EPROM, an EEPROM, a flash memory, a magnetic surface memory, an optical disk, or a CD-ROM. The computer-readable storage medium may also be various devices including one or any combination of the above memories, such as mobile phones, computers, tablet devices, and personal digital assistants, etc.

The computer-readable storage medium stores the computer program thereon. When being executed by a processor, the computer program performs any one of the above processing methods.

In the embodiments of the present disclosure, the disclosed devices and methods may be implemented in other ways. The device embodiments described above are intended to be illustrative. For example, division of units is merely a logical function division. In actual implementation, there may be other division methods. For example, multiple units or components may be combined, or may be integrated into another system, or some features may be ignored, or not implemented. In addition, coupling, direct coupling, or communication connection between the components shown or discussed may be through some interfaces, and the indirect coupling or connection of the devices or units may be in the form of electrical, mechanical, or other connections.

The units described above as separate components may or may not be physically separated. The components shown as units may or may not be physical units, that is, they may be located in one place or distributed to multiple network units. Some or all of the units may be selected according to actual needs to achieve the objectives of the solutions provided by the embodiments.

The methods disclosed in the method embodiments provided in the present disclosure may be combined arbitrarily to obtain new method embodiments without conflict.

The features disclosed in the product embodiments provided in the present disclosure may be combined arbitrarily without conflict to obtain new product embodiments.

The features disclosed in the method or device embodiments provided in the present disclosure may be combined arbitrarily without conflict to obtain new method embodiments or device embodiments.

The above are merely some embodiments of the present disclosure, but the protection scope of the present disclosure is not limited thereto. Any person familiar with the technical field can easily think of changes or substitutions within the technical scope disclosed in the present disclosure. Such changes or substitutions should be covered by the scope of the present disclosure. Therefore, the scope of the present disclosure should be subject to the scope of the appended claims.

1. A processing apparatus, comprising:
a first interface configured to obtain first input data, the first input data coming from a collection device;
a second interface configured to obtain second input data, the second input data coming from a source different from that of the first input data; and
a processing module configured to convert the first input data into a first display signal, convert the second input data into a second display signal, and output one or more of the first display signal and the second display signal.

2. The processing apparatus according to claim 1, wherein when outputting one or more of the first display signal and the second display signal, the processing module is further configured to:
output one or more of the first display signal and the second display signal to a display device, such that the display device displays first display information of the first display signal and/or second display information of the second display signal.

3. The processing apparatus according to claim 2, wherein the first display signal and the second display signal are a same type of signals.

4. The processing apparatus according to claim 1, wherein:
the processing module is connected to one or more display devices, and is configured to output one or more of the first display signal and the second display signal to the one or more display devices.

5. The processing apparatus according to claim 4, wherein when outputting one or more of the first display signal and the second display signal, the processing module is further configured to:
output the first display signal to a first display device to display the first display information of the first display signal; or
output the second display signal to a second display device to display the second display information of the second display signal, the second display device being independent of the first display device; or
output the first display signal to the first display device to display the first display information of the first display signal, and outputting the second display signal to the second display device to display the second display information of the second display signal.

6. The processing apparatus according to claim 1, wherein:
when converting the first input data into the first display signal, the processing module is further configured to convert the first input data into the first display signal according to display parameters carried in the first input data; and
the display parameters of the first input data are determined based on a preset table in the collection device.

7. The processing apparatus according to claim 1, wherein:
the first interface is a mobile industry processing interface (MIPI) of the collective device.

8. The processing apparatus according to claim 1, wherein:
the second interface is an interface connected to a graphics card, a high-definition multimedia interface (HDMI) device, or a display port (DP) device.

9. A display device, comprising:
a first processing apparatus including a first interface and a second interface and configured to convert first input data obtained through the first interface into a first display signal, convert second input data obtained through the second interface into a second display signal, and output one or more of the first display signal and the second display signal, the first input data coming from a collection device, the second input data coming from a source different from that of the first input data; and
a display panel communicatively connected to the first processing apparatus and configured to receive one or more of the first display signal and the second display signal for display;
wherein the first display signal and the second display signal are a same type of signals, the display panel includes a plurality of pixel units, and the first display signal and the second display signal control the plurality of pixel units.

10. The display device according to claim 9, wherein:
the display device is a first display device and further includes a first peripheral interface used to connect to a second display device;
the first processing apparatus further includes a third interface; and
the third interface outputs the first input data through the first peripheral interface to the second display device for display.

11. The display device according to claim 9, wherein:
the display device further includes a collection device and a second peripheral interface used to connect to a third device capable of input and output and independent of the display device;
the collection device is configured to collect image information and convert the image information into the first input data; and
the collection device includes a fourth interface and a fifth interface, the fourth interface is communicatively connected to the first interface to send the first input data to the first processing apparatus, and the fifth interface is communicatively connected to the second peripheral interface to output the first input data to the third device.

12. The display device according to claim 9, wherein:
the display panel determines a first pixel array for displaying the first display signal and a second pixel array for displaying the second display signal; and
when the display panel simultaneously displays the first display signal and the second display signal, the first pixel array interferes with the second pixel array.

13. The display device according to claim 9, further comprising:
a second processing apparatus communicatively connected to the second interface and used to generate the second input data and send the second input data to the first processing apparatus through the second interface.

14. A processing method, comprising:
obtaining first input data and converting the first input data into a first display signal, the first input data coming from a collection device;
obtaining second input data and converting the second input data into a second display signal, the second input data coming from a source different from that of the first input data; and
outputting one or more of the first display signal and the second display signal.

15. The processing method according to claim 14, wherein outputting one or more of the first display signal and the second display signal comprises:
outputting one or more of the first display signal and the second display signal to the display device, such that the display device displays first display information of the first display signal and/or second display information of the second display signal.

16. The processing method according to claim 15, wherein displaying by the display device the first display information of the first display signal and/or the second display information of the second display signal comprises:
displaying all or a portion of the first display information in a first display area of the display device; and
displaying all or a portion of the second display information in a second display area of the display device;
wherein the first display area and the second display area together form an entire display area or a portion of the entire display area of the display device, and a first pixel array corresponding to the first display area interferes with a second pixel array corresponding to the second display area.

17. The processing method according to claim 14, wherein outputting one or more of the first display signal and the second display signal comprises:
outputting the first display signal to a first display device to display the first display information of the first display signal; or
outputting the second display signal to a second display device to display the second display information of the second display signal, the second display device being independent of the first display device; or
outputting the first display signal to a first display device to display the first display information of the first display signal, and outputting the second display signal to a second display device to display the second display information of the second display signal, the second display device being independent of the first display device.

18. The processing method according to claim 14, wherein the first display signal and the second display signal are a same type of signals.
